(19) United States
(12) Patent Application Publication
(10) Pub. No.: US 2025/0365085 A1
(43) Pub. Date: Nov. 27, 2025

(54) Wireless Audio Data Transmission Method and Related Devices

(71) Applicant: Zgmicro Wuxi Corporation, Wuxi (CN)

(72) Inventor: Bin Xu, Wuxi (CN)

(73) Assignee: Zgmicro Wuxi Corporation, Wuxi (CN)

(21) Appl. No.: 19/215,385

(22) Filed: May 22, 2025

(30) Foreign Application Priority Data
May 22, 2024 (CN) 2024106382709

(51) Int. Cl. H04H 20/18; H04H 60/90

(52) U.S. Cl. CPC H04H 20/18; H04H 60/90; H04H 2201/20

(57) ABSTRACT

The present disclosure provides a wireless audio data transmission method and related devices. The method comprises: broadcasting, by a transmitting device, a hybrid auxiliary synchronization packet to a plurality of receiving devices. The hybrid auxiliary synchronization packet comprises a first link information and a second link information, the first link information is used by a first receiving device among the plurality of receiving devices to synchronize with the transmitting device and establish a first Broadcast Isochronous Group (BIG) link, and the second link information is used by a second receiving device among the plurality of receiving devices to synchronize with the transmitting device and establish a second BIG link; transmitting a first broadcast data packet based on the first BIG link, and/or transmitting a second broadcast data packet based on the second BIG link. The method enables more flexible applications of multi-channel wireless broadcast audio.

### CROSS-REFERENCE TO RELATED APPLICATIONS

The present disclosure claims priority benefit to Chinese Patent Application No. 2024106382709 filed in China on May 22, 2024, the entire content of which is incorporated herein by reference.

### TECHNICAL FIELD

The present disclosure relates to the technical field of wireless communication, and in particular, to a wireless audio data transmission method, a wireless audio data transmission device and a wireless audio data transmission system.

### BACKGROUND

Bluetooth Low Energy (BLE) audio technology employs Isochronous Channels protocol, comprising a Connected Isochronous Stream (CIS) link for point-to-point communication and a Connected Isochronous Group (CIG) link composed of at least one CIS link, as well as a Broadcast Isochronous Stream (BIS) link for point-to-multipoint communication and a Broadcast Isochronous Group (BIG) link composed of at least one BIS link. It can provide users with lower power consumption, lower cost, lower delay, higher quality and richer wireless audio services. For example, it can achieve a point-to-multipoint Wireless Broadcast Audio (WBA) function through the BIG link.

In practice, the BIG link is used to realize the point-to-multipoint WBA function.

However, the existing BIG link has a maximum physical layer transmission rate of only 2 Mbps, supports only multiple BIS links to transmit alternately with time-division multiplexing, and shares identical link parameters for the multiple BIS links. This limits the existing BIG link's ability to support low-latency, high-reliability transmission of Multi-Channel Wireless Broadcast Audio (MCWBA) with more than two channels, and does not support asymmetric MCWBA transmission with different audio parameters.

### SUMMARY

The purpose of the present disclosure is to provide a wireless audio data transmission method, a wireless audio data transmission device and a wireless audio data transmission system, which are used to solve technical problems of poor flexibility in audio transmission and insufficient effective bandwidth existing in the related art when implementing the wireless broadcast audio function.

To achieve the purpose, according to one aspect of the present disclosure, a wireless audio data transmission method applied to a transmitting device is provided. The method comprises: broadcasting a hybrid auxiliary synchronization packet to a plurality of receiving devices, wherein the hybrid auxiliary synchronization packet comprises a first link information and a second link information, the first link information is used by a first receiving device among the plurality of receiving devices to synchronize with the transmitting device and establish a first Broadcast Isochronous Group (BIG) link, and the second link information is used by a second receiving device among the plurality of receiving devices to synchronize with the transmitting device and establish a second BIG link, the first receiving device and the second receiving device are different receiving devices, the first link information and the second link information are different link information; transmitting a first broadcast data packet based on the first BIG link, and/or transmitting a second broadcast data packet based on the second BIG link.

According to another aspect of the present disclosure, a wireless audio data transmission method applied to a receiving device is provided. The method comprises: receiving a hybrid auxiliary synchronization packet broadcast by a transmitting device, the hybrid auxiliary synchronization packet comprising first link information and second link information; synchronizing with the transmitting device and establishing a first BIG link based on the first link information, or synchronizing with the transmitting device and establishing a second BIG link based on the second link information; receiving a first broadcast data packet transmitted by the transmitting device based on the first BIG link when synchronized with the transmitting device and the first BIG link is established; and receiving a second broadcast data packet transmitted by the transmitting device based on the second BIG link when synchronized with the transmitting device and the second BIG link is established; wherein the first link information and the second link information are different link information.

According to another aspect of the present disclosure, a wireless audio data transmission system is provided. The system comprises: a plurality of receiving devices; and a transmitting device configured to broadcast a hybrid auxiliary synchronization packet to the plurality of receiving devices, the hybrid auxiliary synchronization packet comprising a first link information and a second link information. The first link information and the second link information are different link information. A first receiving device among the plurality of receiving devices is configured to synchronize with the transmitting device and establish a first Broadcast Isochronous Group (BIG) link via the first link information, and a second receiving device among the plurality of receiving devices is configured to synchronize with the transmitting device and establish a second BIG link via the second link information, wherein the first receiving device and the second receiving device are different receiving devices. The transmitting device is further configured to: transmit a first broadcast data packet based on the first BIG link, and/or transmit a second broadcast data packet based on the second BIG link.

According to another aspect of the present disclosure, a wireless audio data transmission device is provided. The device comprises: a synchronization transmission module, configured to broadcast a hybrid auxiliary synchronization packet to a plurality of receiving devices, wherein the hybrid auxiliary synchronization packet comprises a first link information and a second link information, the first link information is used by a first receiving device among the plurality of receiving devices to synchronize with the transmitting device and establish a first Broadcast Isochronous Group (BIG) link, and the second link information is used by a second receiving device among the plurality of receiving devices to synchronize with the transmitting device and establish a second BIG link, the first receiving device and the second receiving device are different receiving devices, the first link information and the second link information are different link information; and an audio transmission module, configured to transmit a first broadcast data packet based on the first BIG link, and/or transmit a second broadcast data packet based on the second BIG link.

In the present disclosure, the transmitting device is configured to form different broadcast data packets based on different broadcast link information, respectively establish different Broadcast Isochronous Group (BIG) links with different receiving devices among the plurality of receiving devices, and respectively broadcast different broadcast data packets based on the different BIG links, thereby making the application of multi-channel wireless broadcast audio more flexible.

There are many other objects, together with the foregoing attained in the exercise of the disclosure in the following description and resulting in the embodiment illustrated in the accompanying drawings.

### BRIEF DESCRIPTION OF THE DRAWINGS

These and other features, aspects, and advantages of the present disclosure will become better understood with regard to the following description, appended claims, and accompanying drawings wherein:

FIG. 1 is a flow diagram of a wireless audio data transmission method provided according to one embodiment of the present disclosure;

FIG. 2 is a block diagram of a transmitting device provided according to one embodiment of the present disclosure;

FIG. 3 is another block diagram of a transmitting device provided according to another embodiment of the present disclosure;

FIG. 4 is a schematic diagram of a common extended advertising payload format provided according to one embodiment of the present disclosure;

FIG. 5 is a schematic diagram of an extended header format provided according to one embodiment of the present disclosure;

FIG. 6 is a schematic diagram of extended header flags provided according to one embodiment of the present disclosure;

FIG. 7 is a schematic diagram of a slot structure provided according to one embodiment of the present disclosure;

FIG. 8 is a schematic diagram of another slot structure provided according to one embodiment of the present disclosure;

FIG. 9 is a schematic diagram of yet another slot structure provided according to one embodiment of the present disclosure;

FIG. 10 is a flow diagram of another wireless audio data transmission method provided according to one embodiment of the present disclosure;

FIG. 11 is a block diagram of a wireless audio data transmission system provided according to one embodiment of the present disclosure;

FIG. 12 is a block diagram of a wireless audio data transmission device applied to a transmitting device provided according to one embodiment of the present disclosure;

FIG. 13 is a block diagram of another wireless audio data transmission device applied to a receiving device provided according to one embodiment of the present disclosure; and

FIG. 14 is a block diagram of an electronic device provided according to one embodiment of the present disclosure.

### DETAILED DESCRIPTION

The detailed description of the disclosure is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the disclosure do not inherently indicate any particular order nor imply any limitations in the disclosure.

In the related art, the BIG link has a maximum physical layer transmission rate of only 2 Mbps, supports only multiple BIS links to transmit alternately with time-division multiplexing, and uses identical link parameters for the multiple BIS links.

As a result, it is difficult for the BIG link to support low-latency, high-reliability transmission of Multi-Channel Wireless Broadcast Audio (MCWBA) with more than two channels, and is also unsuitable for asymmetric MCWBA transmission with different audio parameters.

Based on this, the present disclosure provides a wireless audio data transmission method and related devices. A transmitting device is configured to form different broadcast data packets based on different broadcast link information, respectively establish different Broadcast Isochronous Group (BIG) links with different receiving devices among a plurality of receiving devices, and respectively broadcast different broadcast data packets over the different BIG links. This satisfies requirements for low-latency, high-reliability transmission of MCWBA with more than two channels, as well as asymmetric MCWBA transmission with different audio parameters, thereby making multi-channel wireless broadcast audio applications more flexible.

In practice, an audio transmission scheme of the present disclosure can support at least two frequency-division multiplexed (FDM) BIG links, i.e., at least two BIG links that simultaneously transmit MCWBA using different frequency channels with time-domain overlapping.

The wireless audio data transmission method and related devices provided in the present disclosure can be applied in scenarios such as cinemas, televisions, airports, and railway stations to provide audio transmission in different languages and/or with different sound qualities for different receiving devices.

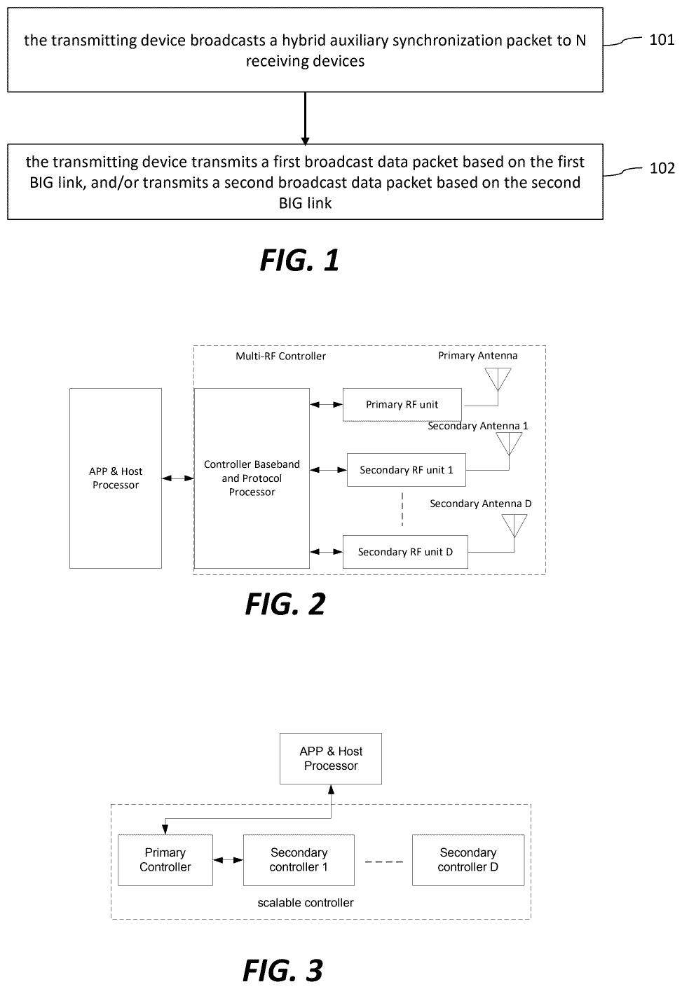

A wireless audio data transmission method applied to a transmitting device is provided according to one embodiment of the present disclosure. As shown in FIG. 1, the method comprises: the transmitting device broadcasts a hybrid auxiliary synchronization packet to N receiving devices at 101.

The hybrid auxiliary synchronization packet comprises a first link information and a second link information. The first link information is used by a first receiving device among the N receiving devices to synchronize with the transmitting device and establish a first Broadcast Isochronous Group (BIG) link. The second link information is used by a second receiving device among the N receiving devices to synchronize with the transmitting device and establish a second BIG link. The first receiving device and the second receiving device are different receiving devices, the first link information and the second link information are different link information, and N is a positive integer.

The first receiving device can be understood as one receiving device that performs broadcast communication with the transmitting device via the first BIG link, and the second receiving device can be understood as one receiving device that performs broadcast communication with the transmitting device via the second BIG link. There may be a plurality of first receiving devices and a plurality of second receiving devices.

It should be understood that the hybrid auxiliary synchronization packet carries multiple link information, and the first link information and the second link information represent any two different link information among the multiple link information. In practice, the hybrid auxiliary synchronization packet may further comprise a third link information for establishing a third BIG link, a fourth link information for establishing a fourth BIG link, etc. The present disclosure does not limit the specific number of link information comprised in the hybrid auxiliary synchronization packet.

Correspondingly, when the hybrid auxiliary synchronization packet further comprises the third link information for establishing the third BIG link and the fourth link information for establishing the fourth BIG link, the N receiving devices further comprise a third receiving device that performs broadcast communication with the transmitting device via the third BIG link and a fourth receiving device that performs broadcast communication with the transmitting device via the fourth BIG link.

It should be noted that the “different receiving devices” in the present disclosure may refer to different receivers, or different receiver units or different receiver modules within the same receiver.

As shown in FIG. 1, the method further comprises: the transmitting device transmits a first broadcast data packet based on the first BIG link, and/or transmits a second broadcast data packet based on the second BIG link at 102.

In one example, the first broadcast data packet and the second broadcast data packet may be different broadcast data packets formed based on different audio streams, e.g., in a bilingual scenario, the first broadcast data packet may be a broadcast data packet formed based on a Chinese audio stream, and the second broadcast data packet may be a broadcast data packet formed based on an English audio stream.

In another example, the first broadcast data packet and the second broadcast data packet may be different broadcast data packets formed based on the same audio stream, e.g., the first broadcast data packet may be a broadcast data packet corresponding to a normal headphone based on a target audio stream, and the second broadcast data packet may be a broadcast data packet corresponding to a hearing-aid headphone based on the target audio stream, wherein a sampling rate and/or a coding rate of the first broadcast data packet is higher than that of the second broadcast data packet.

It may be set that a Hybrid Broadcast Isochronous Group (HBIG) link is used for MCWBA transmission between the transmitting device and the N receiving devices. The HBIG link comprises at least two BIG links with different link information, comprising one primary BIG (PBIG) link and at least one (M≥1) secondary BIG (SBIG) link. The first BIG link and the second BIG link can be understood as any two different BIG links among one PBIG link and at least one SBIG link.

Exemplarily, as shown in FIG. 2, the transmitting device may comprise a Multi-RF (radio frequency) controller and an APP & Host Processor. The Multi-RF controller comprises a primary RF unit with a primary antenna and at least one (D≥1) secondary RF unit with a secondary antenna.

The APP & Host Processor is a collection of all other functional modules in the transmitting device except the Multi-RF controller. In addition to executing a Host protocol defined by a BT Core Specification, the APP & Host Processor also executes Profile protocols, application functions, audio encoding/decoding, audio algorithms, and audio input/output, etc.

A Host controller Interface (HCI) defined by the BT Core Specification is used between the APP & Host Processor and the Multi-RF controller. As shown in FIG. 2, the multiple RF (radio frequency) units of the Multi-RF controller use independent antennas. It should be noted that the multiple RF units of the Multi-RF controller may also share the same antenna.

Both the primary RF unit and the secondary RF units in the Multi-RF controller can transmit based on one or more of the BIG links in the HBIG in a time division multiplexing manner.

As shown in FIG. 3, the transmitting device may also comprise a scalable controller and an APP & Host Processor. The scalable controller comprises a primary controller and at least one (D≥1) secondary controller.

The Host controller Interface (HCI) defined by the BT Core Specification is used between the APP & Host Processor and the primary controller of the scalable controller. A physical interface of HCI may be UART, USB, SDIO, etc.

The primary controller and different secondary controllers are connected in cascade, and their physical interfaces can be UART, USB or SDIO, etc.

The number of cascaded secondary controllers can be adaptively determined according to actual needs. The multiple controllers of the scalable controller may use independent antennas or share the same antenna. Without loss of generality, the “controller” (referring to both the primary controller and the secondary controllers) is controller defined by the BT Core Specification, comprising functions such as Radio, Baseband, Link Controller, Link Manager, or Link Layer, and HCI interface.

Both the primary controller and the secondary controllers in the scalable controller can transmit based on one or more of the BIG links in the HBIG in the use time-division multiplexing manner. The APP & Host Processor transmits multi-channel audio data to the primary controller via the HCI interface, and then the primary controller forwards them to the secondary controllers.

In one embodiment, the audio parameter information used to form the first broadcast data packet is referred to as a first audio parameter information, and the audio parameter information used to form the second broadcast data packet is referred to as a second audio parameter information. The first audio parameter information and the second audio parameter information are different, and satisfy at least one of the following: a parameter value of a first parameter comprised in the first audio parameter information is different from a parameter value of a first parameter comprised in the second audio parameter information, wherein the first parameter is a parameter in the audio parameter information for indicating a sampling rate; a parameter value of a second parameter comprised in the first audio parameter information is different from a parameter value of a second parameter comprised in the second audio parameter information, wherein the second parameter is a parameter in the audio parameter information for indicating a bit depth; a parameter value of a third parameter comprised in the first audio parameter information is different from a parameter value of a third parameter comprised in the second audio parameter information, wherein the third parameter is a parameter in the audio parameter information for indicating a coding rate; and a parameter value of a fourth parameter comprised in the first audio parameter information is different from a parameter value of a fourth parameter comprised in the second audio parameter information, wherein the fourth parameter is a parameter in the audio parameter information for indicating a coding method.

In one embodiment, the first link information and the second link information satisfy at least one of the following: an offset indicated by the first link information is different from an offset indicated by the second link information; a number of links (Num_BIS) indicated by the first link information is different from a number of links indicated by the second link information; a number of sub-events (NSE) indicated by the first link information is different from a number of sub-events indicated by the second link information; and a sub-interval indicated by the first link information is different from a sub-interval indicated by the second link information.

In one embodiment, the transmitting device transmits the first broadcast data packet via at least one communication link in the first BIG link. The transmitting device transmits the second broadcast data packet via at least one communication link in the second BIG link.

In this embodiment, after establishing correspondence between the BIG links and the receiving devices (e.g., the first BIG link corresponds to the first receiving device, and the second BIG link corresponds to the second receiving device), supporting the reception of broadcast data packets via some or all of the communication links in the corresponding BIG link of the receiving device makes audio data transmission more flexible.

In the present disclosure, for one specific receiving device or a category of receiving devices, it may correspond to one BIG link or multiple BIG links. When corresponding to multiple BIG links, the aforementioned receiving device or the category of receiving devices can receive the broadcast data packets through some or all of the communication links in the corresponding multiple BIG links. For example, if one receiving device corresponds to a BIG link A and a BIG link B, wherein the BIG link A comprises communication links a1 and a2, and the BIG link B comprises communication links b1 and b2, the receiving device can receive the broadcast data packets through at least one of the communication links a1, a2, b1, and b2.

In one embodiment, the hybrid auxiliary synchronization packet comprises primary link information, which comprises a plurality of enable parameters. Each enable parameter of the plurality of enable parameters corresponds to one of a plurality of auxiliary BIG links, and a parameter value of each enable parameter indicates whether the corresponding auxiliary BIG link is enabled.

The first BIG link is an enabled one of the auxiliary BIG links, and/or the second BIG link is an enabled one of the auxiliary BIG links.

Further, the hybrid auxiliary synchronization packet is a packet in a common extended advertising payload format, wherein an extended header of the hybrid auxiliary synchronization packet carries the primary link information, and the plurality of enable parameter occupy part or all of bits in a reserved field of the primary link information.

When it is set that a Hybrid Broadcast Isochronous Group (HBIG) link is used for MCWBA transmission between the transmitting device and the N receiving devices, and the HBIG link comprises at least two BIG links with different link information, comprising one primary BIG (PBIG) link and at least one (M≥1) secondary BIG (SBIG) link. The primary link information is the link information of the PBIG. In this case, the hybrid auxiliary synchronization packet further comprises at least one secondary link information corresponding one-to-one to at least one SBIG, and the auxiliary BIG links are the SBIGs.

Exemplarily, the hybrid auxiliary synchronization packet may be a Hybrid Auxiliary Synchronization (HB_AUX_SYNC_IND) Protocol Data Unit (PDU). The HB_AUX_SYNC_IND PDU may be defined with reference to the BLE protocol.

The difference between the HB_AUX_SYNC_IND PDU and an Auxiliary Synchronization (AUX_SYNC_IND) PDU defined by the BLE protocol lies in that, in addition to the BIG link information (BIGInfo) carried in an Additional Controller Advertising Data (ACAD) field of the AUX_SYNC_IND PDU, the HB_AUX_SYNC_IND PDU also adds indication information of the SBIG link and BIG link information (i.e., secondary link information) of the SBIG link in an Advertising Data (AdvData) field.

The BIGInfo is used to provide a BIG peripheral device (i.e., the receiving device in the present disclosure) with the link information such as a starting point, an interval, BIS link number, access address, and retransmission times of the BIG link established by a BIG center device (i.e., the transmitting device in the present disclosure), which will not be described in detail in the present disclosure.

Without loss of generality, the BIGInfo of the PBIG carried in the ACAD field of the HB_AUX_SYNC_IND PDU is defined as PBIG Info in the present disclosure, and the BIGInfo of the SBIG link carried in the AdvData field is defined as SBIG Info in the present disclosure. It should be noted that in practice, the PBIG Info and the SBIG Info may be stored in the same field or different fields of the hybrid auxiliary synchronization packet, which is not limited in the present disclosure.

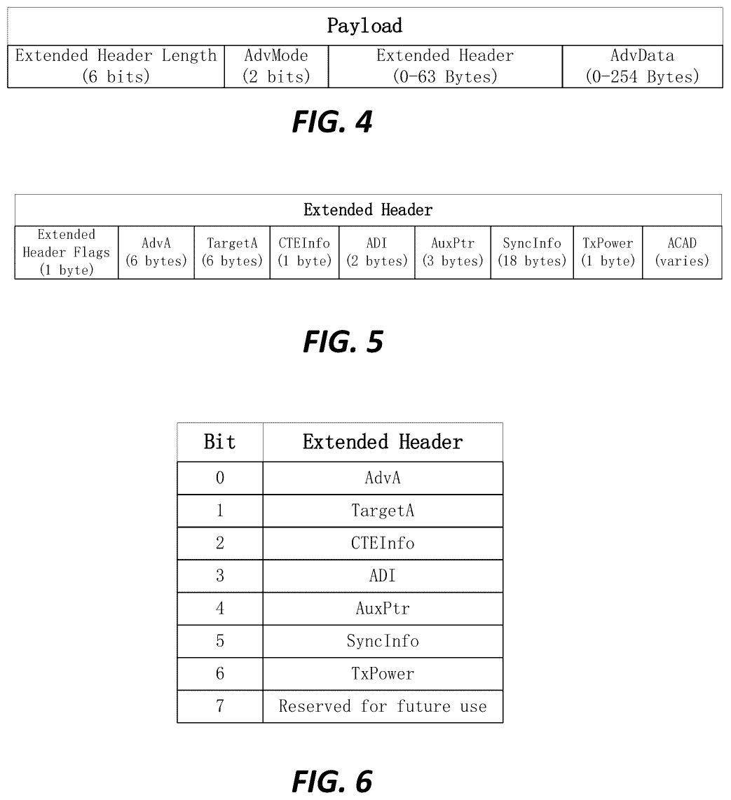

Similar to the AUX_SYNC_IND PDU defined by the BLE protocol, the HB_AUX_SYNC_IND PDU adopts a Common Extended Advertising Payload Format of a BLE specification shown in FIG. 4, which comprises a 6-bit Extended Header Length, a 2-bit AdvMode, an Extended Header of 0-63 bytes, and Advertising Data (AdvData) of up to 254 bytes.

As shown in FIG. 5, the extended header may comprise fields such as Extended Header Flags, AdvA, TargetA, CTEInfo, ADI, AuxPtr, SyncInfo, TxPower, and ACAD.

The Extended Header Flags are extended header flag bits. As shown in FIG. 6, each bit corresponds to a field of the extended header. A bit set to 1 indicates corresponding field exists in the extended header, and a bit set to 0 indicates the corresponding field does not exist in the extended header. The AdvA represents a device address of an advertising transmitting device, The TargetA represents a device address of a target device, the CTEInfo represents Constant Tone Extension (CTE) information, the ADI represents Advertising Data information, the AuxPtr represents an auxiliary advertisement pointer, the SyncInfo represents synchronization information, the TxPower represents transmission power, and the ACAD represents Additional Controller Advertising Data.

The HB_AUX_SYNC_IND PDU carries the PBIG Info through the ACAD, wherein the PBIG Info comprises an 8-bit reserved field (RFU: Reserved for Future Use). The HB_AUX_SYNC_IND PDU defines part or all of bits in the reserved field of the PBIG Info as SBIG link enable bits (i.e., enable parameters), which are used to indicate whether the SBIG links are enabled and how many SBIG links are enabled.

For example, these SBIG link enable bits are, from low to high, HB EN_1, HB EN_2, . . . , HB EN_M. One SBIG link enable bit set to 1 indicates the corresponding SBIG link is enabled, while one SBIG link enable bit set to 0 indicates the corresponding SBIG link is not enabled. When one SBIG link enable bit is set to 1, the corresponding SBIG Info is carried in the AdvData field of the HB_AUX_SYNC_IND PDU. The SBIG Info in the AdvData is arranged in sequence according to its sequence number, wherein SBIG1 Info corresponds to the link information of the SBIG link with sequence number 1, SBIGm Info corresponds to the SBIG link with sequence number m, and SBIGM Info corresponds to the SBIG link with sequence number M.

In one embodiment, time slots occupied by the first broadcast data packet and the second broadcast data packet do not overlap, and/or frequency domain channels occupied by the first broadcast data packet and the second broadcast data packet do not overlap.

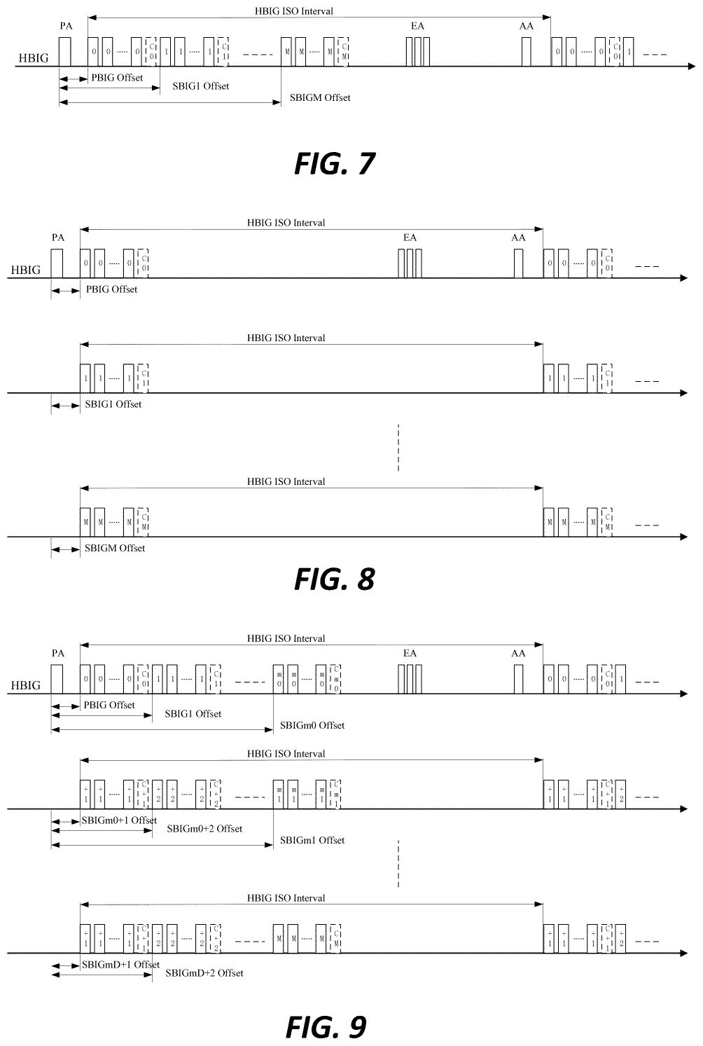

Exemplarily, a time-division multiplexing (TDM) coexisting slot structure between the PBIG link and the SBIG links in the HBIG link is shown in FIG. 7. The communication time of the HBIG link is divided into isochronous intervals with a length of HBIG ISO Interval.

Within one HBIG ISO Interval, solid boxes labeled “0” represent BIS PDUs transmitted on the PBIG link, and dashed box labeled “C0” represents BIG Control PDU transmitted by the PBIG link, wherein the dashed line indicates that transmission may or may not occur in the current ISO interval. The solid boxes labeled “1” represent the BIS PDUs transmitted on the SBIG link numbered 1 (SBIG1), the dashed box labeled “C1” represents the BIG Control PDU transmitted on the SBIG1 link, the solid boxes labeled “M” represent BIS PDUs transmitted on the SBIG link numbered M (SBIGM), and the dashed box labeled “CM” represents the BIG Control PDU transmitted on the SBIGM link.

The PBIG link and all the SBIG links share the same ADV_EXT_IND PDU (denoted as EA in FIG. 7) transmitted on a primary advertising channel, the same AUX_ADV_IND PDU (denoted as AA in FIG. 7) transmitted on a secondary advertising channel, and the same HB_AUX_SYNC_IND PDU (denoted as PA in FIG. 7) transmitted on a periodic advertising channel for synchronization of the HBIG peripheral devices (i.e., the receiving devices described above). A BIG offset (PBIG Offset) carried in the PBIG Info of the PBIG link is smaller than SBIG offsets (SBIG1 Offset, . . . , SBIGM Offset) carried in the SBIG Info of the SBIG links, it is indicated that the BIS PDU of the PBIG link is transmitted first, and then the BIS PDUs of the SBIG links are transmitted in turn. The transmission timing of EA, AA, and PA is consistent with the specification of the BLE protocol.

A frequency-division multiplexing (FDM) coexisting slot structure between the PBIG link and the SBIG link in the HBIG link is shown in FIG. 8. The communication time of the HBIG link is divided into isochronous intervals with a length of HBIG ISO Interval.

Within one HBIG ISO Interval, the solid boxes labeled “0” represent BIS PDUs transmitted on the PBIG link, and the dashed box labeled “C0” represents BIG Control PDU transmitted on the PBIG link, wherein the dashed line indicates that transmission may or may not occur in the current ISO interval. The solid boxes labeled “1” represent BIS PDUs transmitted on the SBIG1 link, the dashed box labeled “C1” represents BIG Control PDU transmitted by the SBIG1 link, the solid boxes labeled “M” represent BIS PDUs transmitted by the SBIGM link, and the dashed box labeled “CM” represents BIG Control PDU transmitted by the SBIGM link. The PBIG link and all SBIG links share the same ADV_EXT_IND PDU (denoted as EA in FIG. 8), the same AUX_ADV_IND PDU (denoted as AA in FIG. 8), and the same HB_AUX_SYNC_IND PDU (denoted as PA in FIG. 8) for synchronization of the HBIG peripheral devices.

The BIG offset (PBIG Offset) carried in the PBIG Info of the PBIG link is the same as or close to the SBIG offsets (SBIG1 Offset, . . . , SBIGM Offset) carried in the SBIG Info of the SBIG links, it is indicated that the BIS PDUs of the PBIG link and the SBIG links can be transmitted synchronously in the time domain, or in other words, the BIS PDUs transmitted on the PBIG and the SBIG links overlaps in the time domain while being distinguished by different frequency channels. The transmission timing of EA, AA, and PA is consistent with the specifications of the BLE protocol.

Without loss of generality, in FIG. 8, M is equal to D, meaning the number of the SBIG links is the same as the number of secondary RF units or secondary controllers, and each RF unit or each controller transmits on corresponding one of the PBIG link or the SBIG links.

The slot structure for joint time-division and frequency-division multiplexing coexistence between the PBIG link and the SBIG links in the HBIG link is shown in FIG. 9. Compared to FIGS. 7 and 8, all the PBIG link and the SBIG links are divided into D+1 frequency-division multiplexing groups. The number of time-division multiplexing groups in each frequency-division multiplexing group is respectively m0+1, m1, m2, . . . , mD, and m0+1+m1+m2+ . . . +mD=M+1, wherein M is the number of the SBIG links. Each frequency-division multiplexing group is transmitted by D+1 different RF units or controllers. It can be seen that the slot structures shown in FIGS. 7 and 8 are two special cases of FIG. 9.

The link information of at least two BIG links of the PBIG link and the SBIG links in the HBIG link is different. For example, at least one of the PBIG Offset or the SBIG offset, the number of BIS links (Num_BIS), the number of sub-events (NSE), the sub-interval (Sub_Interval), etc. is different. All parameters refer to definition of BIGInfo in the BLE specification, which is not repeated in the present disclosure.

Exemplarily, when the PBIG link and the SBIG links coexist through frequency-division multiplexing, a frequency hopping algorithm 1 in the BLE protocol can be adopted by configuring the PBIG link and the SBIG links with different initial frequency channels and restricting a frequency hopping offset to be greater than the total number of the BIS links in the PBIG link and the SBIG link, while keeping the channel offset identical for each BIS link, thereby avoiding frequency channel conflicts among all BIS links.

Alternatively, a frequency hopping algorithm 2 in the BLE protocol can be used, such that the PBIG link and the SBIG links have different access addresses, and different frequency channel sequences are generated based on the access addresses, resulting in mostly non-overlapping frequency channels for the PBIG link and the SBIG links. In the case of overlap in a few frequency channels, a round-robin avoidance method is adopted: either the PBIG link or the SBIG links temporarily suspend transmission on the conflicting frequency channel to prevent mutual interference.

In summary, the transmission and reception process of MCWBA in the present disclosure is as follows: the application and host processor of the transmitting device classifies multi-channel audio data according to different parameters based on application requirements, respectively compresses and encodes them into audio data streams suitable for PBIG and SBIG transmission, and encapsulates them into corresponding Service Data Units (SDUs), and then transmits them to the controller via the HCI interface.

The application and host processor then configures the controller to establish the HBIG link according to the PBIG Info of the PBIG link and the SBIG Info of the SBIG links. The controller further encapsulates the SDUs of each channel into BIS PDUs for the PBIG link or the SBIG links and transmits the corresponding BIS PDUs via the PBIG link or the SBIG links. If frequency-division multiplexing transmission is required, the data is transmitted to the Multi-RF controller or the scalable controller in parallel.

As shown in the slot structures of FIGS. 7-9, the receiving device first searches for the ADV_EXT_IND PDU, then receives the AUX_ADV_IND PDU, and receives the HB_AUX_SYNC_IND PDU according to the synchronization information of the AUX_ADV_IND PDU. Then, the receiving device sequentially receives the corresponding BIS PDUs according to the PBIG Info of the PBIG link or the SBIG Info of the SBIG link provided by the HB_AUX_SYNC_IND PDU.

Generally, each receiving device only receives audio data from one channel or part of the channels, and thus only receives all or part of the BIS PDUs of the BIS links in the PBIG link or the SBIG link and the audio data they carry. Different types of receiving devices receive different types of BIG links and their corresponding channels.

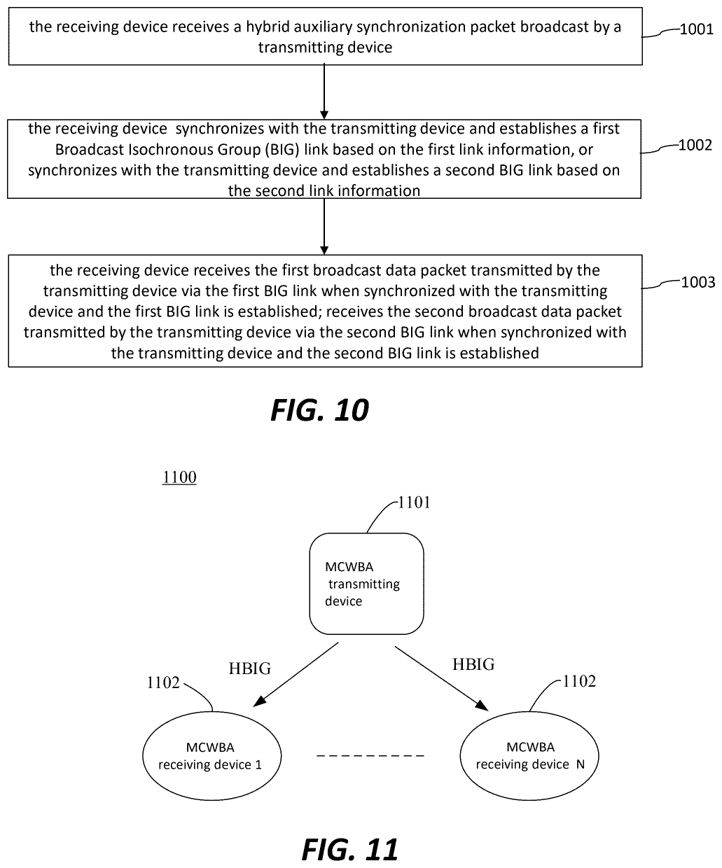

A wireless audio data transmission method applied to a receiving device is provided according to one embodiment of the present disclosure. As shown in FIG. 10, the method comprises: the receiving device receives a hybrid auxiliary synchronization packet broadcast by a transmitting device at 1001, wherein the hybrid auxiliary synchronization packet comprises a first link information and a second link information; synchronizes with the transmitting device and establishes a first Broadcast Isochronous Group (BIG) link based on the first link information, or synchronizes with the transmitting device and establishes a second BIG link based on the second link information at 1002; and receives the first broadcast data packet transmitted by the transmitting device via the first BIG link when synchronized with the transmitting device and the first BIG link is established; receives the second broadcast data packet transmitted by the transmitting device via the second BIG link when synchronized with the transmitting device and the second BIG link is established at 1003.

The first link information and the second link information are different.

In one embodiment, audio parameter information used to form the first broadcast data packet is referred to as a first audio parameter information, and audio parameter information used to form the second broadcast data packet is referred to as a second audio parameter information, and the first audio parameter information and the second audio parameter information are different.

The first audio parameter information and the second audio parameter information satisfy at least one of: a parameter value of a first parameter comprised in the first audio parameter information is different from a parameter value of a first parameter comprised in the second audio parameter information, wherein the first parameter is a parameter in the audio parameter information for indicating a sampling rate; a parameter value of a second parameter comprised in the first audio parameter information is different from a parameter value of a second parameter comprised in the second audio parameter information, wherein the second parameter is a parameter in the audio parameter information for indicating a bit depth; a parameter value of a third parameter comprised in the first audio parameter information is different from a parameter value of a third parameter comprised in the second audio parameter information, wherein the third parameter is a parameter in the audio parameter information for indicating a coding rate; and a parameter value of a fourth parameter comprised in the first audio parameter information is different from a parameter value of a fourth parameter comprised in the second audio parameter information, wherein the fourth parameter is a parameter in the audio parameter information for indicating a coding method.

In one embodiment, the first link information and the second link information satisfy at least one of the following: an offset value indicated by the first link information is different from an offset value indicated by the second link information; a number of links indicated by the first link information is different from a number of links indicated by the second link information; a number of sub-events (NSE) indicated by the first link information is different from a number of sub-events indicated by the second link information; and a sub-interval indicated by the first link information is different from a sub-interval indicated by the second link information.

In one embodiment, time slots occupied by the first broadcast data packet and the second broadcast data packet do not overlap, and/or frequency domain channels occupied by the first broadcast data packet and the second broadcast data packet do not overlap.

In one embodiment, the receiving device receives the first broadcast data packet transmitted by the transmitting device via at least one communication link in the first BIG link. The receiving device receives the second broadcast data packet transmitted by the transmitting device via at least one communication link in the second BIG link.

In one embodiment, the hybrid auxiliary synchronization packet comprises primary link information, which comprises a plurality of enable parameters. The plurality of enable parameters has a one-to-one correspondence with a plurality of auxiliary BIG links, and a parameter value of each enable parameter indicates whether the corresponding auxiliary BIG link is enabled.

The first broadcast isochronous group link is an enabled one of the auxiliary BIG links, and/or the second broadcast isochronous group link is an enabled one of the auxiliary BIG links.

In one embodiment, the hybrid auxiliary synchronization packet is a packet in a common extended advertising payload format, an extended header of the hybrid auxiliary synchronization packet carries the primary link information, and the plurality of enable parameters occupies part or all of bits in a reserved field of the primary link information.

The wireless audio data transmission method provided in this embodiment of the present disclosure corresponds to various processes related to the receiving device in the foregoing embodiments and can achieve the same technical effects. To avoid repetition, details are not repeated here.

A wireless audio data transmission system is provided according to one embodiment of the present disclosure. As shown in FIG. 11, the wireless audio data transmission system 1100 comprises: a transmitting device 1101 and N receiving devices 1102, wherein N is a positive integer.

The transmitting device 1101 is configured to broadcast a hybrid auxiliary synchronization packet to the N receiving devices 1102, wherein the hybrid auxiliary synchronization packet comprises a first link information and a second link information, and N is a positive integer.

A first receiving device among the N receiving devices 1102 is configured to synchronize with the transmitting device 1101 via the first link information and establish a first Broadcast Isochronous Group (BIG) link. A second receiving device among the N receiving devices 1102 is configured to synchronize with the transmitting device 1101 via the second link information and establish a second BIG link, wherein the first receiving device and the second receiving device are different receiving devices 1102.

The transmitting device 1101 is configured to: transmit a first broadcast data packet based on the first BIG link, and/or transmit a second broadcast data packet based on the second BIG link.

In one embodiment, audio parameter information used to form the first broadcast data packet is referred to as a first audio parameter information, and audio parameter information used to form the second broadcast data packet is referred to as a second audio parameter information, and the first audio parameter information and the second audio parameter information are different.

In one embodiment, the first audio parameter information and the second audio parameter information satisfy at least one of: a parameter value of a first parameter comprised in the first audio parameter information is different from a parameter value of a first parameter comprised in the second audio parameter information, wherein the first parameter is a parameter in the audio parameter information for indicating a sampling rate; a parameter value of a second parameter comprised in the first audio parameter information is different from a parameter value of a second parameter comprised in the second audio parameter information, wherein the second parameter is a parameter in the audio parameter information for indicating a bit depth; a parameter value of a third parameter comprised in the first audio parameter information is different from a parameter value of a third parameter comprised in the second audio parameter information, wherein the third parameter is a parameter in the audio parameter information for indicating a coding rate; and a parameter value of a fourth parameter comprised in the first audio parameter information is different from a parameter value of a fourth parameter comprised in the second audio parameter information, wherein the fourth parameter is a parameter in the audio parameter information for indicating a coding method.

In one embodiment, the first link information and the second link information satisfy at least one of the following: an offset value indicated by the first link information is different from an offset value indicated by the second link information; a number of links indicated by the first link information is different from a number of links indicated by the second link information; a number of sub-events indicated by the first link information is different from a number of sub-events indicated by the second link information; and a sub-interval indicated by the first link information is different from a sub-interval indicated by the second link information;

In one embodiment, time slots occupied by the first broadcast data packet and the second broadcast data packet do not overlap, and/or frequency domain channels occupied by the first broadcast data packet and the second broadcast data packet do not overlap.

The wireless audio data transmission system provided in this embodiment of the present disclosure corresponds to the various processes related to the transmitting device and the receiving device in the aforementioned embodiments and can achieve the same technical effects. To avoid repetition, details are not repeated here.

For ease of understanding, an example is illustrated as follows:

Take a bilingual asymmetric multi-channel wireless audio broadcasting application in a cinema as an example. As shown in a MCWBA system shown in FIG. 11, the MCWBA transmitting device 1101 is a cinema playback device, and the MCWBA receiving devices 1102 are headphones, which are divided into two categories: normal headphones and hearing-aid headphones.

The cinema playback device transmits a total of 8 asymmetric channels of audio. The HBIG links between the cinema playback device and the headphones comprise one PBIG links and three SBIG links. The cinema playback device carries the PBIG Info in the ACAD field of the HB_AUX_SYNC_IND PDU, wherein three SBIG link enable bits in the PBIG Info are set to 1, namely, HB EN_1, HB EN_2, and HB EN_3 from low to high are set to 1, and the others are set to 0.

Specifically, the PBIG link transmits Chinese dual-channel audio for the normal headphones to receive, the SBIG1 link transmits Chinese dual-channel audio for the hearing-aid headphones to receive, the SBIG2 link transmits English dual-channel audio for the normal headphones to receive, and the SBIG3 link transmits English dual-channel audio for the hearing-aid headphones to receive.

Each of the PBIG links, the SBIG1 link, the SBIG2 link, and the SBIG3 link comprises two BIS links. One BIS link transmits left-channel audio, and the other BIS link transmits right-channel audio. Each headphone connects to two BIS links in one BIG links to receive the left and right channel audio, wherein the normal headphones connect to the PBIG link or the SBIG2 link, and the hearing-aid headphones connect to the SBIG1 link or the SBIG3 link.

In this example, it is specified that the PBIG link and the SBIG links adopt the frequency hopping algorithm 2 in the BLE protocol to avoid frequency channel conflicts between frequency-division multiplexed BIS links through different frequency hopping sequences. The HBIG ISO Interval is 10 ms, and the asymmetric multi-channel audio of the cinema playback device uses a Low Complexity Communication Codec (LC3) specified in the BLE Audio protocol.

The cinema playback device as the MCWBA transmitting device adopts the architecture shown in FIG. 3, and comprises a scalable controller and an APP & Host Processor. The scalable controller comprises one primary controller and one secondary controller.

Main parameters of the PBIG link comprise: dual-channel audio with a sampling rate of 48 KHz using LC3 encoding with a frame length of 10 ms, an encoding rate of 96 kbps per channel, a Service Data Unit (SDU) size of 120 bytes per channel, 2 BIS links with each BIS link transmitting one audio channel, Number of Sub-Events (NSE) equals 3, Burst Number (BN) equals 1, Immediate Repetition Count (IRC) equals 3, and Pre-Transmission Offset (PTO) value equals 0.

The BIS PDU has a payload size of 120 bytes and contains one SDU for one channel.

A BLE 2 Mbps physical layer is used for transmission, each BIS PDU occupies an air time slot of 540 μs, a minimum time slot interval (Time of Minimum Slot Space, T_MSS) between BIS PDUs is 180 us, and it takes 720 us to send each BIS PDU.

The interval for transmitting HB_AUX_SYNC_IND PDUs on the periodic advertising channel is 60 ms, and the offset (PBIG Offset) between the start point for transmitting the HB_AUX_SYNC_IND PDU and the start point of the PBIG link is 1.23 ms.

The main parameters of the SBIG1 link comprise: dual-channel audio with a sampling rate of 24 kHz using LC3 encoding with a frame length of 10 ms, an encoding rate of 48 kbps per channel, a Service Data Unit (SDU) size of 60 bytes per channel, 2 BIS links with each BIS link transmitting one audio channel, Number of Sub-Events (NSE) equals 4, Burst Number (BN) equals 1, Immediate Repetition Count (IRC) equals 4, and Pre-Transmission Offset (PTO) value equals 0.

The BIS PDU has a payload size of 60 bytes and contains one SDU for one channel. The BLE 2 Mbps physical layer is used for transmission, each BIS PDU occupies an air time slot of 300 μs, a minimum time slot interval (T_MSS) between BIS PDUs is 180 us, and it takes 480 us to send each BIS PDU. The SBIG1 Offset is 6 ms.

The main parameters of the SBIG2 link comprise: dual-channel audio with a sampling rate of 48 KHz using LC3 encoding with a frame length of 10 ms, an encoding rate of 96 kbps per channel, a Service Data Unit (SDU) size of 120 bytes per channel, 2 BIS links with each BIS link transmitting one audio channel, Number of Sub-Events (NSE) equals 3, Burst Number (BN) equals 1, Immediate Repetition Count (IRC) equals 3, and Pre-Transmission Offset (PTO) value equals 0.

The BIS PDU has a payload size of 120 bytes and contains one SDU for one channel. The BLE 2 Mbps physical layer is used for transmission, each BIS PDU occupies an air time slot of 540 μs, a minimum time slot interval (T_MSS) between BIS PDUs is 180 us, and it takes 720 us to send each BIS PDU. Transmission of 6 BIS PDUs occupies 4.32 ms in total. The SBIG2 Offset is 1.23 ms.

The main parameters of the SBIG3 link comprise: dual-channel audio with a sampling rate of 24 kHz using LC3 encoding with a frame length of 10 ms, a coding rate of 48 kbps per channel, a service data unit size of 60 bytes per channel, 2 BIS links with each BIS link transmitting one audio channel, Number of Sub-Events equals 4, Burst Number equals 1, Immediate Repetition Count equals 3, and Pre-Transmission Offset value equals 0.

The BIS PDU has a payload size of 60 bytes and contains one SDU for one channel. The BLE 2 Mbps physical layer is used for transmission, each BIS PDU occupies an air time slot of 300 μs, the minimum time slot interval between BIS PDUs is 180 us and it takes 480 us to send each BIS PDU. Transmission of 6 BIS PDUs occupies 3.84 ms in total. The SBIG3 Offset is 6 ms.

It can be seen from the above example that, by using the HBIG link, the cinema playback device can support 8 asymmetric multi-channel wireless broadcast audios, wherein different channels can flexibly support different sampling rates and encoding rates, and multiple channels can solve the problem of bandwidth limitation by means of frequency division multiplexing.

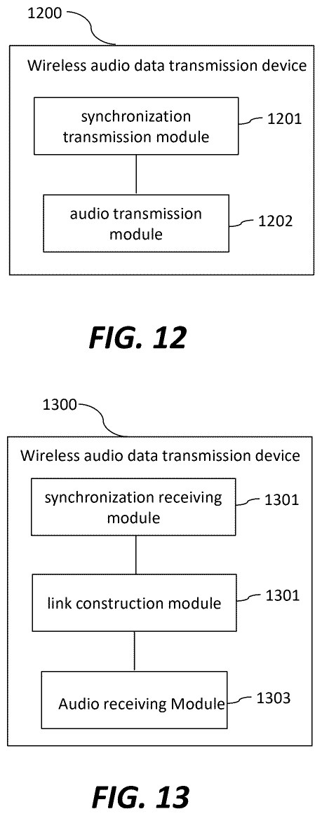

A wireless audio data transmission device applied to a transmitting device is provided according to one embodiment of the present disclosure. As shown in FIG. 12, the device 1200 comprises: a synchronization transmission module 1201 configured to broadcast a hybrid auxiliary synchronization packet to N receiving devices, wherein the hybrid auxiliary synchronization packet comprises a first link information and a second link information. The first link information is used by a first receiving device among the N receiving devices to synchronize with the transmitting device and establish a first Broadcast Isochronous Group (BIG) link, and the second link information is used by a second receiving device among the N receiving devices to synchronize with the transmitting device and establish a second BIG link. The first receiving device and the second receiving device are different receiving devices, and N is a positive integer.

As shown in FIG. 12, the device 1200 further comprises: an audio transmission module 1202 configured to transmit a first broadcast data packet based on the first BIG link, and/or transmit a second broadcast data packet based on the second BIG link, wherein the audio parameter information used to form the first broadcast data packet is different from that used to form the second broadcast data packet.

In one embodiment, audio parameter information used to form the first broadcast data packet is referred to as a first audio parameter information, and audio parameter information used to form the second broadcast data packet is referred to as a second audio parameter information, and the first audio parameter information and the second audio parameter information are different.

In one embodiment, the first audio parameter information and the second audio parameter information satisfy at least one of: a parameter value of a first parameter comprised in the first audio parameter information is different from a parameter value of a first parameter comprised in the second audio parameter information, wherein the first parameter is a parameter in the audio parameter information for indicating a sampling rate; a parameter value of a second parameter comprised in the first audio parameter information is different from a parameter value of a second parameter comprised in the second audio parameter information, wherein the second parameter is a parameter in the audio parameter information for indicating a bit depth; a parameter value of a third parameter comprised in the first audio parameter information is different from a parameter value of a third parameter comprised in the second audio parameter information, wherein the third parameter is a parameter in the audio parameter information for indicating a coding rate; and a parameter value of a fourth parameter comprised in the first audio parameter information is different from a parameter value of a fourth parameter comprised in the second audio parameter information, wherein the fourth parameter is a parameter in the audio parameter information for indicating a coding method.

In one embodiment, the first link information and the second link information satisfy at least one of: an offset value indicated by the first link information is different from an offset value indicated by the second link information; a number of links indicated by the first link information is different from a number of links indicated by the second link information; a number of sub-events indicated by the first link information is different from a number of sub-events indicated by the second link information; and a sub-interval indicated by the first link information is different from a sub-interval indicated by the second link information.

In one embodiment, the time slots occupied by the first broadcast data packet and the second broadcast data packet do not overlap, and/or the frequency domain channels occupied by the first broadcast data packet and the second broadcast data packet do not overlap.

In one embodiment, the audio transmission module 1202 is specifically configured to: transmit the first broadcast data packet via at least one communication link in the first BIG link, and/or transmit the second broadcast data packet via at least one communication link in the second BIG link.

In one embodiment, the hybrid auxiliary synchronization packet comprises primary link information comprising a plurality of enable parameters, wherein each enable parameter of the plurality of enable parameters corresponds to one of a plurality of auxiliary BIG links; and a parameter value of each enable parameter indicates whether the corresponding auxiliary BIG link is enabled.

The first broadcast isochronous group link is an enabled one of the auxiliary BIG links, and/or the second broadcast isochronous group link is an enabled one of the auxiliary BIG links.

In one embodiment, the hybrid auxiliary synchronization packet is a packet in a common extended advertising payload format, an extended header of the hybrid auxiliary synchronization packet carries the primary link information, and the plurality of enable parameters occupies part or all of bits in a reserved field of the primary link information.

The wireless audio data transmission device 1200 provided in the embodiments of the present disclosure can implement each process in the wireless audio data transmission method for a transmitting device side. For the sake of brevity, details are not repeated here.

A wireless audio data transmission device applied to a receiving device is provided according to one embodiment of the present disclosure. As shown in FIG. 13, the device 1300 comprises: a synchronization receiving module 1301 configured to receive a hybrid auxiliary synchronization packet broadcast by a transmitting device, wherein the hybrid auxiliary synchronization packet comprises a first link information and a second link information; a link construction module 1302 configured to synchronize with the transmitting device and establish a first Broadcast Isochronous Group (BIG) link based on the first link information, or synchronize with the transmitting device and establish a second BIG link based on the second link information; and an audio receiving module 1303 configured to receive a first broadcast data packet transmitted by the transmitting device via the first BIG link when synchronized with the transmitting device and the first BIG link is established, and receive a second broadcast data packet transmitted by the transmitting device via the second BIG link when synchronized with the transmitting device and the second BIG link is established.

The first link information and the second link information are different.

In one embodiment, audio parameter information used to form the first broadcast data packet is referred to as a first audio parameter information, and audio parameter information used to form the second broadcast data packet is referred to as a second audio parameter information, and the first audio parameter information and the second audio parameter information are different.

In one embodiment, the first audio parameter information and the second audio parameter information satisfy at least one of: a parameter value of a first parameter comprised in the first audio parameter information is different from a parameter value of a first parameter comprised in the second audio parameter information, wherein the first parameter is a parameter in the audio parameter information for indicating a sampling rate; a parameter value of a second parameter comprised in the first audio parameter information is different from a parameter value of a second parameter comprised in the second audio parameter information, wherein the second parameter is a parameter in the audio parameter information for indicating a bit depth; a parameter value of a third parameter comprised in the first audio parameter information is different from a parameter value of a third parameter comprised in the second audio parameter information, wherein the third parameter is a parameter in the audio parameter information for indicating a coding rate; and a parameter value of a fourth parameter comprised in the first audio parameter information is different from a parameter value of a fourth parameter comprised in the second audio parameter information, wherein the fourth parameter is a parameter in the audio parameter information for indicating a coding method.

In one embodiment, the first link information and the second link information satisfy at least one of the following: an offset value indicated by the first link information is different from an offset value indicated by the second link information; a number of links indicated by the first link information is different from a number of links indicated by the second link information; a number of sub-events indicated by the first link information is different from a number of sub-events indicated by the second link information; and a sub-interval indicated by the first link information is different from a sub-interval indicated by the second link information.

In one embodiment, the time slots occupied by the first broadcast data packet and the second broadcast data packet do not overlap, and/or the frequency domain channels occupied by the first broadcast data packet and the second broadcast data packet do not overlap.

In one embodiment, the Audio Receiving Module 1303 is specifically configured to: receive the first broadcast data packet transmitted by the transmitting device via at least one communication link in the first BIG link when synchronized with the transmitting device and the first BIG link is established; receive the second broadcast data packet transmitted by the transmitting device via at least one communication link in the second BIG link when synchronized with the transmitting device and the second BIG link is established.

In one embodiment, the hybrid auxiliary synchronization packet comprises primary link information comprising a plurality of enable parameters. Each enable parameter of the plurality of enable parameters corresponds to one of a plurality of auxiliary BIG links; and a parameter value of each enable parameter indicates whether the corresponding auxiliary BIG link is enabled.

The first broadcast isochronous group link is an enabled one of the auxiliary BIG links, and/or the second broadcast isochronous group link is an enabled one of the auxiliary BIG links.

The hybrid auxiliary synchronization packet further comprises at least one secondary link information corresponding one-to-one to at least one auxiliary BIG link.

In one embodiment, the hybrid auxiliary synchronization packet is a packet in the common extended advertising payload format. The extended header of the hybrid auxiliary synchronization packet carries the primary link information, and the plurality of enable parameters occupy part or all of the bits in the reserved field of the primary link information.

The wireless audio data transmission device 1300 provided in the embodiments of the present disclosure can implement each process in the wireless audio data transmission method for a receiving device side. To avoid repetition, details are not repeated here.

According to the embodiments of the present disclosure, an electronic device and a readable storage medium are also provided.

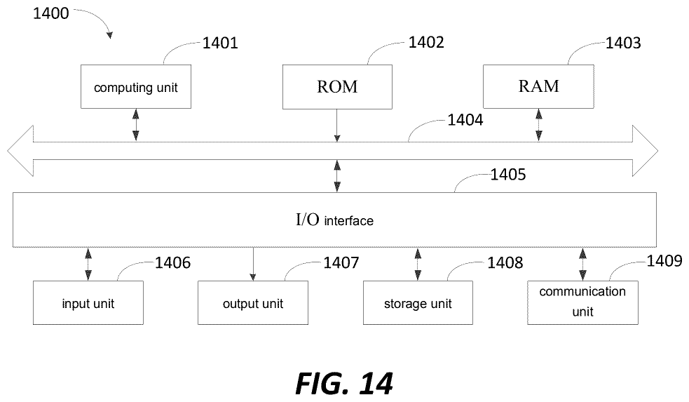

FIG. 14 shows a schematic block diagram of an example electronic device 1400 that can be used to implement the embodiments of the present disclosure. As shown in FIG. 14, the device 1400 comprises a computing unit 1401, which can perform various appropriate actions and processing based on computer programs stored in a Read-Only Memory (ROM) 1402 or loaded into a Random Access Memory (RAM) 1403 from a storage unit 1408. The RAM 1403 can also store various programs and data required for the operation of the device 1400. The computing unit 1401, the ROM 1402, and the RAM 1403 are interconnected via a bus 1404. An Input/Output (I/O) interface 1405 is also connected to the bus 1404.

Multiple components of the device 1400 are connected to the I/O interface 1405, including: an input unit 1406, such as a keyboard, mouse, etc.; an output unit 1407, such as various types of displays, speakers, etc.; a storage unit 1408, such as a magnetic disk, optical disk, etc.; and a communication unit 1409, such as a network card, modem, wireless communication transceiver, etc. The communication unit 1409 allows the device 1400 to exchange information/data with other devices through computer networks such as the Internet and/or various telecommunication networks.

The computing unit 1401 can be various general and/or special processing components with processing and computing capabilities. Some examples of the computing unit 1401 comprise but are not limited to a Central Processing Unit (CPU), a Graphic Processing Unit (GPU), various dedicated Artificial Intelligence (AI) computing chips, various computing units running machine learning model algorithms, a Digital Signal Processing (DSP), and any appropriate processor, controller, microcontroller, etc. The computing unit 1401 executes the various methods and processing described above, such as the wireless audio data transmission method. For example, in some embodiments, the wireless audio data transmission method can be implemented as a computer software program tangibly embodied in a machine-readable medium, such as the storage unit 1408. In some embodiments, part or all of the computer programs can be loaded and/or installed onto the device 1400 via the ROM 1402 and/or the communication unit 1409. When the computer program is loaded into the RAM 1403 and executed by the computing unit 1401, one or more operations of the wireless audio data transmission method described above can be performed. Alternatively, in other embodiments, the computing unit 1401 can be configured to execute the wireless audio data transmission method by any other suitable means (e.g., via firmware).

The embodiments of the present disclosure are described above in conjunction with the accompanying drawings, but the present disclosure is not limited to the specific embodiments described above, the specific embodiments described above are merely illustrative and not limiting, and the person of ordinary skill in the field of the present disclosure, without departing from the purpose of the application and the scope of protection of the claims, may also make many forms, all of which are under the protection of the present disclosure.

Although preferred embodiments of the present disclosure have been described, additional changes and modifications to these embodiments may be made once the basic creative concepts are known to those skilled in the art. The appended claims are therefore intended to be interpreted to comprise preferred embodiments and all changes and modifications falling within the scope of the present disclosure.

Obviously, a person skilled in the art may make various changes and variations to the application without departing from the spirit and scope of the application. Thus, if these modifications and variations of the present disclosure fall within the scope of the claims and their equivalent technologies, the application is also intended to comprise these changes and variations.

What is claimed is:

1. A wireless audio data transmission method applied to a transmitting device, comprising:
broadcasting a hybrid auxiliary synchronization packet to a plurality of receiving devices, wherein the hybrid auxiliary synchronization packet comprises a first link information and a second link information, the first link information is used by a first receiving device among the plurality of receiving devices to synchronize with the transmitting device and establish a first Broadcast Isochronous Group (BIG) link, and the second link information is used by a second receiving device among the plurality of receiving devices to synchronize with the transmitting device and establish a second BIG link, the first receiving device and the second receiving device are different receiving devices, the first link information and the second link information are different link information; and
transmitting a first broadcast data packet based on the first BIG link, and/or transmitting a second broadcast data packet based on the second BIG link.

2. The method according to claim 1, wherein audio parameter information used to form the first broadcast data packet is referred to as a first audio parameter information, and audio parameter information used to form the second broadcast data packet is referred to as a second audio parameter information, and the first audio parameter information and the second audio parameter information are different,
the first audio parameter information and the second audio parameter information satisfy at least one of:
a parameter value of a first parameter comprised in the first audio parameter information is different from a parameter value of a first parameter comprised in the second audio parameter information, wherein the first parameter is a parameter in the audio parameter information for indicating a sampling rate;
a parameter value of a second parameter comprised in the first audio parameter information is different from a parameter value of a second parameter comprised in the second audio parameter information, wherein the second parameter is a parameter in the audio parameter information for indicating a bit depth;
a parameter value of a third parameter comprised in the first audio parameter information is different from a parameter value of a third parameter comprised in the second audio parameter information, wherein the third parameter is a parameter in the audio parameter information for indicating a coding rate; and
a parameter value of a fourth parameter comprised in the first audio parameter information is different from a parameter value of a fourth parameter comprised in the second audio parameter information, wherein the fourth parameter is a parameter in the audio parameter information for indicating a coding method;
the first link information and the second link information satisfy at least one of:
an offset value indicated by the first link information is different from an offset value indicated by the second link information;
a number of links indicated by the first link information is different from a number of links indicated by the second link information;
a number of sub-events indicated by the first link information is different from a number of sub-events indicated by the second link information; and
a sub-interval indicated by the first link information is different from a sub-interval indicated by the second link information;
wherein time slots occupied by the first broadcast data packet and the second broadcast data packet do not overlap, and/or frequency domain channels occupied by the first broadcast data packet and the second broadcast data packet do not overlap.

3. The method according to claim 1, wherein the transmitting the first broadcast data packet based on the first BIG link comprises:
transmitting the first broadcast data packet via at least one communication link in the first BIG link;
the transmitting the second broadcast data packet based on the second BIG link comprises:
transmitting the second broadcast data packet via at least one communication link in the second BIG link.

4. The method according to claim 1, wherein the hybrid auxiliary synchronization packet comprises primary link information comprising a plurality of enable parameters, wherein each enable parameter of the plurality of enable parameters corresponds to one of a plurality of auxiliary BIG links; and a parameter value of each enable parameter indicates whether the corresponding auxiliary BIG link is enabled;
wherein the first broadcast isochronous group link is an enabled one of the auxiliary BIG links, and/or the second broadcast isochronous group link is an enabled one of the auxiliary BIG links,
the hybrid auxiliary synchronization packet further comprises at least one secondary link information corresponding one-to-one to at least one auxiliary BIG link.

5. The method according to claim 4, wherein the hybrid auxiliary synchronization packet is a packet in a common extended advertising payload format, an extended header of the hybrid auxiliary synchronization packet carries the primary link information, and the plurality of enable parameters occupy part or all of bits in a reserved field of the primary link information.

6. A wireless audio data transmission method applied to a receiving device, comprising:
receiving a hybrid auxiliary synchronization packet broadcast by a transmitting device, the hybrid auxiliary synchronization packet comprising first link information and second link information;
synchronizing with the transmitting device and establishing a first BIG link based on the first link information, or synchronizing with the transmitting device and establishing a second BIG link based on the second link information;
receiving a first broadcast data packet transmitted by the transmitting device based on the first BIG link when synchronized with the transmitting device and the first BIG link is established; and
receiving a second broadcast data packet transmitted by the transmitting device based on the second BIG link when synchronized with the transmitting device and the second BIG link is established;
wherein the first link information and the second link information are different link information.

7. The method according to claim 6, wherein audio parameter information used to form the first broadcast data packet is referred to as a first audio parameter information, and audio parameter information used to form the second broadcast data packet is referred to as a second audio parameter information, and the first audio parameter information and the second audio parameter information are different,
the first audio parameter information and the second audio parameter information satisfy at least one of:
a parameter value of a first parameter comprised in the first audio parameter information is different from a parameter value of a first parameter comprised in the second audio parameter information, wherein the first parameter is a parameter in the audio parameter information for indicating a sampling rate;
a parameter value of a second parameter comprised in the first audio parameter information is different from a parameter value of a second parameter comprised in the second audio parameter information, wherein the second parameter is a parameter in the audio parameter information for indicating a bit depth;
a parameter value of a third parameter comprised in the first audio parameter information is different from a parameter value of a third parameter comprised in the second audio parameter information, wherein the third parameter is a parameter in the audio parameter information for indicating a coding rate; and
a parameter value of a fourth parameter comprised in the first audio parameter information is different from a parameter value of a fourth parameter comprised in the second audio parameter information, wherein the fourth parameter is a parameter in the audio parameter information for indicating a coding method;
the first link information and the second link information satisfy at least one of:
an offset value indicated by the first link information is different from an offset value indicated by the second link information;
a number of links indicated by the first link information is different from a number of links indicated by the second link information;
a number of sub-events indicated by the first link information is different from a number of sub-events indicated by the second link information; and
a sub-interval indicated by the first link information is different from a sub-interval indicated by the second link information;
wherein time slots occupied by the first broadcast data packet and the second broadcast data packet do not overlap, and/or frequency domain channels occupied by the first broadcast data packet and the second broadcast data packet do not overlap.

8. The method according to claim 6, wherein the receiving a first broadcast data packet transmitted by the transmitting device based on the first BIG link comprises:
receiving the first broadcast data packet transmitted by the transmitting device based on at least one communication link in the first BIG link;
the receiving a second broadcast data packet transmitted by the transmitting device based on the second BIG link comprises:
receiving the second broadcast data packet transmitted by the transmitting device based on at least one communication link in the second BIG link.

9. The method according to claim 6, wherein the hybrid auxiliary synchronization packet comprises primary link information comprising a plurality of enable parameters,
wherein each enable parameter of the plurality of enable parameters corresponds to one of a plurality of auxiliary BIG links; and a parameter value of each enable parameter indicates whether the corresponding auxiliary BIG link is enabled;
wherein the first broadcast isochronous group link is an enabled one of the auxiliary BIG links, and/or the second broadcast isochronous group link is an enabled one of the auxiliary BIG links,
the hybrid auxiliary synchronization packet further comprises at least one secondary link information corresponding one-to-one to at least one auxiliary BIG link.

10. The method according to claim 9, wherein the hybrid auxiliary synchronization packet is a packet in a common extended advertising payload format, an extended header of the hybrid auxiliary synchronization packet carries the primary link information, and the plurality of enable parameters occupy part or all of bits in a reserved field of the primary link information.

11. A wireless audio data transmission system, comprising:
a plurality of receiving devices; and
a transmitting device configured to broadcast a hybrid auxiliary synchronization packet to the plurality of receiving devices, the hybrid auxiliary synchronization packet comprising a first link information and a second link information,
wherein the first link information and the second link information are different link information;
wherein a first receiving device among the plurality of receiving devices is configured to synchronize with the transmitting device and establish a first Broadcast Isochronous Group (BIG) link via the first link information, and a second receiving device among the plurality of receiving devices is configured to synchronize with the transmitting device and establish a second BIG link via the second link information, wherein the first receiving device and the second receiving device are different receiving devices; and
wherein the transmitting device is further configured to: transmit a first broadcast data packet based on the first BIG link, and/or transmit a second broadcast data packet based on the second BIG link.

12. The system according to claim 11, wherein audio parameter information used to form the first broadcast data packet is referred to as a first audio parameter information, and audio parameter information used to form the second broadcast data packet is referred to as a second audio parameter information, and the first audio parameter information and the second audio parameter information are different,
the first audio parameter information and the second audio parameter information satisfy at least one of:
a parameter value of a first parameter comprised in the first audio parameter information is different from a parameter value of a first parameter comprised in the second audio parameter information, wherein the first parameter is a parameter in the audio parameter information for indicating a sampling rate;
a parameter value of a second parameter comprised in the first audio parameter information is different from a parameter value of a second parameter comprised in the second audio parameter information, wherein the second parameter is a parameter in the audio parameter information for indicating a bit depth;
a parameter value of a third parameter comprised in the first audio parameter information is different from a parameter value of a third parameter comprised in the second audio parameter information, wherein the third parameter is a parameter in the audio parameter information for indicating a coding rate; and
a parameter value of a fourth parameter comprised in the first audio parameter information is different from a parameter value of a fourth parameter comprised in the second audio parameter information, wherein the fourth parameter is a parameter in the audio parameter information for indicating a coding method;
the first link information and the second link information satisfy at least one of:
an offset value indicated by the first link information is different from an offset value indicated by the second link information;
a number of links indicated by the first link information is different from a number of links indicated by the second link information;
a number of sub-events indicated by the first link information is different from a number of sub-events indicated by the second link information; and
a sub-interval indicated by the first link information is different from a sub-interval indicated by the second link information;
wherein time slots occupied by the first broadcast data packet and the second broadcast data packet do not overlap, and/or frequency domain channels occupied by the first broadcast data packet and the second broadcast data packet do not overlap.

13. The system according to claim 12, wherein the hybrid auxiliary synchronization packet comprises primary link information comprising a plurality of enable parameters,
wherein each enable parameter of the plurality of enable parameters corresponds to one of a plurality of auxiliary BIG links; and a parameter value of each enable parameter indicates whether the corresponding auxiliary BIG link is enabled;
wherein the first broadcast isochronous group link is an enabled one of the auxiliary BIG links, and/or the second broadcast isochronous group link is an enabled one of the auxiliary BIG links,
the hybrid auxiliary synchronization packet further comprises at least one secondary link information corresponding one-to-one to at least one auxiliary BIG link.

14. The system according to claim 13, wherein the hybrid auxiliary synchronization packet is a packet in a common extended advertising payload format, an extended header of the hybrid auxiliary synchronization packet carries the primary link information, and the plurality of enable parameters occupy part or all of bits in a reserved field of the primary link information.

15. A wireless audio data transmission device, comprising:
a synchronization transmission module configured to broadcast a hybrid auxiliary synchronization packet to a plurality of receiving devices, wherein the hybrid auxiliary synchronization packet comprises a first link information and a second link information, the first link information is used by a first receiving device among the plurality of receiving devices to synchronize with the transmitting device and establish a first Broadcast Isochronous Group (BIG) link, and the second link information is used by a second receiving device among the plurality of receiving devices to synchronize with the transmitting device and establish a second BIG link, the first receiving device and the second receiving device are different receiving devices, the first link information and the second link information are different link information; and
an audio transmission module configured to transmit a first broadcast data packet based on the first BIG link, and/or transmit a second broadcast data packet based on the second BIG link.

16. The system according to claim 15, wherein audio parameter information used to form the first broadcast data packet is referred to as a first audio parameter information, and audio parameter information used to form the second broadcast data packet is referred to as a second audio parameter information, and the first audio parameter information and the second audio parameter information are different,
the first audio parameter information and the second audio parameter information satisfy at least one of:
a parameter value of a first parameter comprised in the first audio parameter information is different from a parameter value of a first parameter comprised in the second audio parameter information, wherein the first parameter is a parameter in the audio parameter information for indicating a sampling rate;
a parameter value of a second parameter comprised in the first audio parameter information is different from a parameter value of a second parameter comprised in the second audio parameter information, wherein the second parameter is a parameter in the audio parameter information for indicating a bit depth;
a parameter value of a third parameter comprised in the first audio parameter information is different from a parameter value of a third parameter comprised in the second audio parameter information, wherein the third parameter is a parameter in the audio parameter information for indicating a coding rate; and
a parameter value of a fourth parameter comprised in the first audio parameter information is different from a parameter value of a fourth parameter comprised in the second audio parameter information, wherein the fourth parameter is a parameter in the audio parameter information for indicating a coding method;
the first link information and the second link information satisfy at least one of:
an offset value indicated by the first link information is different from an offset value indicated by the second link information;
a number of links indicated by the first link information is different from a number of links indicated by the second link information;
a number of sub-events indicated by the first link information is different from a number of sub-events indicated by the second link information; and
a sub-interval indicated by the first link information is different from a sub-interval indicated by the second link information;
wherein time slots occupied by the first broadcast data packet and the second broadcast data packet do not overlap, and/or frequency domain channels occupied by the first broadcast data packet and the second broadcast data packet do not overlap.

17. The device according to claim 16, wherein the hybrid auxiliary synchronization packet comprises primary link information comprising a plurality of enable parameters,
wherein each enable parameter of the plurality of enable parameters corresponds to one of a plurality of auxiliary BIG links; and a parameter value of each enable parameter indicates whether the corresponding auxiliary BIG link is enabled;
wherein the first broadcast isochronous group link is an enabled one of the auxiliary BIG links, and/or the second broadcast isochronous group link is an enabled one of the auxiliary BIG links,
the hybrid auxiliary synchronization packet further comprises at least one secondary link information corresponding one-to-one to at least one auxiliary BIG link.

18. The device according to claim 17, wherein the hybrid auxiliary synchronization packet is a packet in a common extended advertising payload format, an extended header of the hybrid auxiliary synchronization packet carries the primary link information, and the plurality of enable parameters occupy part or all of bits in a reserved field of the primary link information.
